(19) United States
(12) Patent Application Publication
(10) Pub. No.: US 2009/0063575 A1
(43) Pub. Date: Mar. 5, 2009

(54) SYSTEMS, METHODS AND COMPUTER PRODUCTS FOR DYNAMIC IMAGE CREATION FOR COPY SERVICE DATA REPLICATION MODELING

(75) Inventors: David R. Blea, Tucson, AZ (US); Errol J. Calder, Vail, AZ (US); Steven M. Kern, Tucson, AZ (US); Gregory E. McBride, Vail, AZ (US); William D. Olsen, Tucson, AZ (US); Jeffrey R. Placer, Tucson, AZ (US); Benjamin J. Randall, Tucson, AZ (US); Todd B. Schlomer, Tucson, AZ (US); Jacob A. Stevens, Tucson, AZ (US); John J. Wolfgang, Midlothian, VA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES COPORATION, Armonk, NY (US)

(21) Appl. No.: 11/845,585

(22) Filed: Aug. 27, 2007

(51) Int. Cl. G06F 12/00

(52) U.S. Cl. 707/201

(57) ABSTRACT

Modeling a set of images representing a group of data replication states and displaying, to a customer, the group of data replication states and generating the model that graphically displays a copy solution; including creating an image data modeling definition, where the image data modeling definition includes a definition of the set of images representing the group of data replication states. The method also includes creating a group of dynamic images, using the definition of the set of images representing the group of data replication states included in the image data modeling definition, where creating the group of dynamic images includes: specifying how to draw site and role specific parts of the group of dynamic images and specifying how to draw arrows that connect each role of the group of dynamic images.

### TRADEMARKS

IBM® is a registered trademark of the International Business Machines Corporation, Armonk, N.Y., U.S.A. Other names used herein may be trademarks and registered trademarks, or trade or product names of International Business Machines Corporation or other companies. For example, JAVASCRIPT is a trademark of Sun Microsystems, Inc.

### TECHNICAL FIELD

This invention relates generally to networked computer system administration and management. More particularly, this invention relates to storage management products that require images to display solutions to hardware management. This invention can be applied to any system running any service provider application.

### BACKGROUND

In general, when copying data using a storage system device, customers and/or users do not have means of visualizing what their data is actually doing at any given time. This can cause a problem especially if the data replication solution is complex. Furthermore, when dealing with little to zero data loss disaster recovery solutions the entire solutions are very complex. Having a way to model the solution to the customer/user in a visual way can help the customer/user monitor data replication transactions by giving them the ability to see at a glance what their data replication solutions are doing at any given moment. One way to do this would be to create many static images that could potentially model the data replication solution to the customer/user at all the different states that the solution could be in. One of the problems with creating static images for these data replication solutions is the numerous states that these static images can be in. Instead of having a single picture for each state, which could mean hundreds of static pictures, there needs to be a way to model these data replication solutions so they can be represented visually to the customer/user in a dynamic solution. The other problem with static images is the fact that data replication solutions can change at any given time for each different customer/user; which would then require a countless number of static images and/or pictures. Each customer/user has different requirements for their data replication solutions, which then requires numerous specialized images for each customer/user; this is just not possible when dealing with thousands of customers/users at one time. This problem has been observed in general in many types of service provider replication applications including point-in-time copy applications, synchronous copy applications, asynchronous copy applications and combinations of two or more of the afore mentioned types of copy applications. Thus, replication application problems are not limited to the above mentioned applications. Other applications and vendors are similarly affected.

Therefore, the need exists for systems, methods and computer products for a new technique to model the images that will represent the data replication states that will be displayed to the customer/user, wherein the new modeling technique will allow a plurality of different images (where the number of different images in the plurality of images is unlimited) to be generated for each of the customer's/user's data replication solutions, given the different data replication solution states.

Further, the need exists for a way to automatically create a model for these data replication state images, which will make the image creation process dynamic and seamless to the customer/user. This will allow any number of data replication solutions and image state possibilities to be dynamically generated when customers and/or users want to view images of their data replication solution states.

### SUMMARY OF THE INVENTION

A method and system of modeling a set of images representing a group of data replication states and displaying the group of data replication states to a customer and/or a user in computer automated networked storage system devices configured in a networked automated computer system are disclosed. The method and system create an image data modeling definition; which includes a definition of a set of images representing the group of data replication states. Using the definition of the set of images representing the group of data replication states included in the image data modeling definition, a group of dynamic images are created. Creating the group of dynamic images includes: specifying how to draw site and role specific parts of the group of dynamic images by listing a site specification in a site tag. The site specification includes a set of up to two roles associated with the site. A first role of the set of up to two roles is either a source of any copy type or a target of one of either a synchronous or asynchronous copy type. A second role of the set of up to two roles is a target of a point in time copy; specifying site labels in a session image by multiple name tags included in the site tag. The site tag further includes a group of up to a first role tag and a second role tag, where each role tag specifies a role for the site and each role tag includes a name for each role and a specification for a state of each role, where each role specifies a role image that can be drawn in a dynamic session image. The site tag includes the first role tag and the second role tag, the second role tag always specifies the target of a point-in-time copy relationship and a second role always appears underneath a first role when the role image is drawn. Further, using a rolepair tag enclosing information used to draw an arrow between two specific role images, the method and system specifies how to draw arrows that connect each role of the group of dynamic images by: using the rolepair tag enclosing information used to draw an arrow between two specific role images, wherein the rolepair tag encompasses five inner tags including one or more role inner tags, a cptype inner tag, a direction inner tag, a participating inner tag and an active inner tag. Two role inner tags are used to specify roles between which arrows are drawn. Names featured in the role must be the same as two of the roles specified in the role tags used to specify the sites. The method and system specify which type of copy is being used for arrows by the cptype inner tag, where the type of copy is either a point-in-time copy, synchronous copy, or asynchronous copy or any combination of two or more of point-in-time copy, synchronous copy or asynchronous copy. The direction inner tag specifies a direction to draw one or more point-in-time copy arrows, synchronous copy arrows or asynchronous copy arrows. Acceptable arguments for the direction inner tag are left and right. The method and system then selects either filled or unfilled icons representing arrows by the active inner tag; and marking with the participating inner tag when arrows can be shown in the group of dynamic images; displaying the group of data replication states to the customer/user; and generating the entire copy solution model definition that is used to graphically display an entire copy solution, where the entire copy solution can be a zero data loss solution or one or more different types of copy solutions, based on customer/user needs; and generating the dynamic visual display of the entire copy solution using the copy solution model definition to cause the user to see the dynamic visual display of the entire copy solution.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates operations of the dynamic image creation for copy service data replication modeling method.

FIG. 2 illustrates an arrow spanning from H1 to H3; which shows that the entire copy solution goes from site 1 (H1) to site 3 (H3).

FIG. 3 illustrates the system implementing operations of the method illustrated in FIG. 1.

### DETAILED DESCRIPTION

Exemplary embodiments of the method and system for modeling a set of images representing a group of data replication states and displaying the group of data replication states to a customer and/or user are described in detail below. The disclosed exemplary embodiments are intended to be illustrative only, since numerous modifications and variations therein will be apparent to those of ordinary skill in the art. In reference to the drawings, like numbers will indicate like parts continuously throughout the view. The exemplary embodiments disclosed herein address problems in . . . components in the IBM enterprise operating system environment. However, the disclosed exemplary embodiments can be applied to any system running any service provider application. Further, the terms “a”, “an”, “first”, “second” and “third” herein do not denote limitations of quantity, but rather denote the presence of one or more of the referenced item(s).

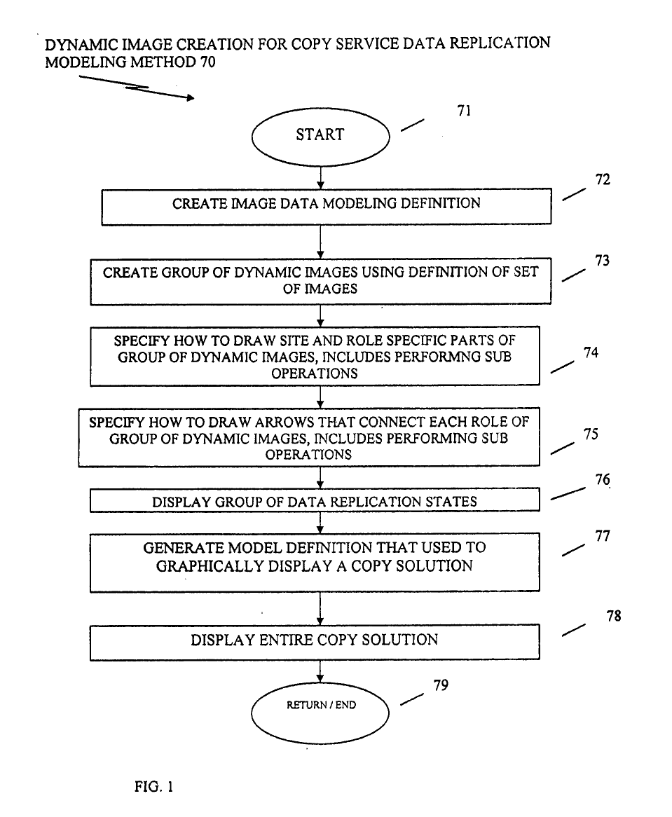

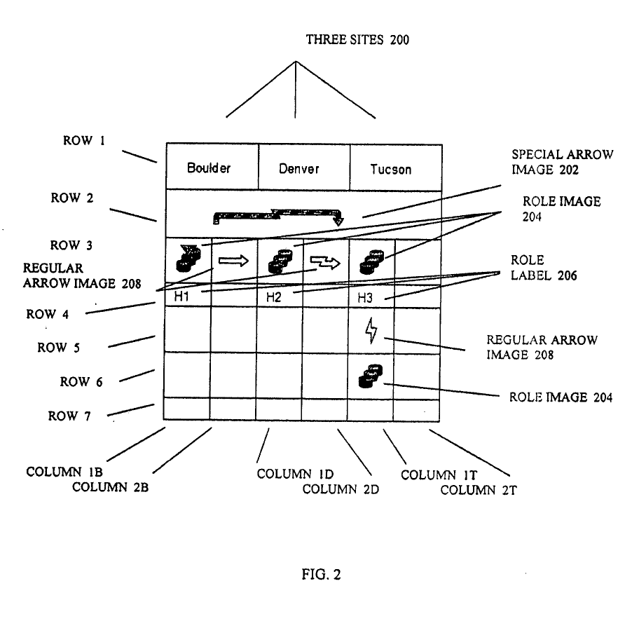

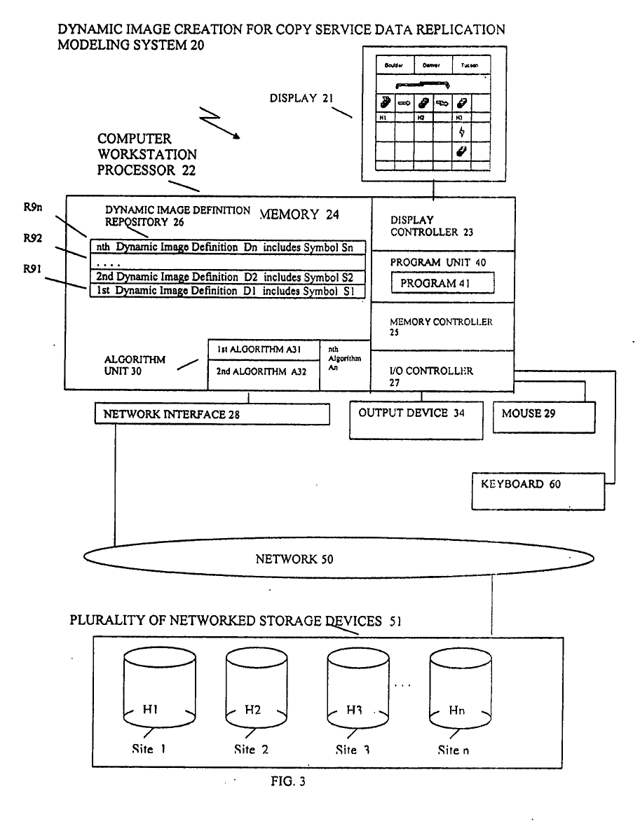

A dynamic image creation for copy service data replication modeling method 70 (herein referred to as “method 70”) and a dynamic image creation for copy service data replication modeling system 20 (herein referred to as “system 20”) of a Total Storage Productivity center for Replication (TPC-R) implementing method 70 are illustrated in FIGS. 1 and 3 respectively. FIG. 2 illustrates a dynamic image of a copy solution 102.

Referring to FIG. 3, system 20 includes computer workstation processor 22, which contains memory 24. Algorithm unit 30 resides in memory 24 and contains a plurality of algorithms including first algorithm A31 and second algorithm A32 up to nth algorithm An. Also, residing in system 20 is program unit 40, containing program 41. Memory 24 also contains a dynamic image definition repository 26, which contains a plurality of repository entry locations R91, R92 and up to Rn, which hold and/or store dynamic image definitions D1, D2 up to Dn and images/symbols S1, S2 up to Sn.

In the exemplary embodiment, system 20 includes a combination of controllers including display controller 23, memory controller 25 and input/output (I/O) controller 27 and a combination of computer peripheral devices cooperatively coupled to system 20 including display 21, a set of input devices including keyboard 60 and mouse 29, network interface 28, and output device 34, via standard interface connectivity. Network interface 28 cooperatively couples computer workstation processor 22 via network 50 (where network 50 can be a wide area network such as the Internet or a local area network, including an intranet or an extranet) to a plurality of networked storage system devices 51 for copying data to. The plurality of networked storage system devices 51 includes storage devices represented by role names for a plurality of sites, as illustrated in FIG. 3; in the exemplary embodiment H1 is a role name at site 1. H2 is the role name at site 2, H3 is the role name at site 3 and Hn is the role name at site n.

Display 21 displays copy solutions. In the exemplary embodiment FIG. 2 illustrates copy solutions for sites at Boulder, Denver and Tucson. Therefore, display 21 can display the copy solutions for the sites at Boulder, Denver and Tucson, as illustrated in FIG. 3. Furthermore, display 21 can display copy solutions for each of or any combination of a plurality of sites including site 1, site 2, site 3 up to site n.

Referring to FIG. 1 and FIG. 3, at operation start 71 of method 70, an operator/user, using an input device such as any one of input devices mouse 29 or keyboard 60, activates and initiates program 41, where method 70 is stored as executable program code on a computer executable medium. The operator/user activates program 41 and performs other selections in method 70 by making entries using keyboard 60 or mouse 29; thus, causing program 41 to be executed by computer workstation processor 22 to perform the operations of method 70 thereby creating an image data modeling definition, where the image data modeling definition includes a definition of a set of images representing a group of data replication states. The image data modeling definition technique allows an unlimited number of different images to be generated from a set of images representing each of the customer's/user's data replication solutions, given the different data replication solution states of a group of data replication states. Having a way to automatically create a model for these data replication state images makes the image creation process dynamic and seamless to the customer/user. Thus, any number of data replication solutions and image state possibilities can be dynamically generated when users want to view images of their data replication solution states. The model for the data replication images uses Extensible Markup Language (XML) to define what the images display. Using XML allows greater flexibility in the process of creating dynamic images and makes it easier to represent any type of image generated. There are, of course, other ways to define these images other than XML. The XML model definitions of these images are used by program 41 to create the images dynamically. To generate the actual images, the XML copy solution definition is used to display the different parts of the solution into a grid type setup. Thus a full copy solution image can be pieced together to provide a full copy solution visual image display to the user. The dynamic image creation in TPC-R consists of two parts; the image data modeling definition and the image creation process. The image data model defines what the image will actually look like while the image creation process uses this image data model to create the images.

Referring to FIGS. 1, 2 and 3, at operation 72, program 41, executed by system 20, causes system 20 to perform the operations of creating a group of dynamic images, using the definition of the set of images representing the group of data replication states included in the image data modeling definition. The dynamic images are drawn in a grid that controls the layout of the sub-images contained within the grid. Cells in the grid may contain volume images, arrow images, site labels, or role labels (roles are a type of copy method). The grid can be broken down into a number of columns, where each column represents a customer site, as illustrated in FIG. 2. The grid lines show where the different parts fall into the full image. The full copy solution image could actually consist of multiple images in a table or explicitly drawn out into a single image in the same format. Referring to FIG. 2, the first and uppermost row, i.e., row 1 in the grid of FIG. 2 accommodates customer site names. The next row down from the top, i.e., row 2 accommodates a role images and a regular arrow images. Thus, FIG. 2 illustrates a grid including a full dynamic session image of a three customer site copy solution for a combination Synchronous-Asynchronous copy type, where the three sites 200 are Boulder Denver and Tucson. This combination Synchronous-Asynchronous copy type can also be referred to as a Metro Global Mirror (i.e., MGM) copy type. Volume sets fall into the grid and are connected together with the different copy type images. A special row (i.e., row 2) with a special arrow 202 is included in the Dynamic Session Image. This special arrow image 202 spans role images 204, which shows that the copy solution goes from site 1 (H1) to site 3 (H3). Each of the three role labels, designated role label 206, corresponds to the three sites 200, i.e., the H1 role label, H2 role label and H3 role label correspond to the Boulder, Denver and Tucson sites respectively. The complete three site dynamic session image illustrated in FIG. 2 is composed of various site sub-images. In the exemplary embodiment, referring to FIG. 2, column 1B to column 2B from row 7 up to row 3 and including the Boulder site of row 1 comprises the Boulder site sub-image. Correspondingly, column 1D to Column 2D from row 7 up to row 3 and including the Denver site of row 1 comprises the Denver site sub-image; and column 1T to Column 2T from row 7 up to row 3 and including the Tucson site of row 1 comprises the Tucson site sub-image.

The following Tables contain descriptions/definitions and images of icons, and symbols stored in repository entry locations R91, R92 and up to Rn in dynamic image definition repository 26. The following tables 1-5 specify iconic symbols used as images in TPC-R for a point-in-time copy type, a Synchronous copy type, an Asynchronous copy type or any combination of the above copy types, such as a combination of Synchronous-Asynchronous copy type. The point-in-line copy type can also be referred to as a FlashCopy (FC) copy type. The synchronous copy type can also be referred to as a Metro Mirror (MM) copy type, and the Asynchronous copy type can also be referred to as a Global Mirror (GM) copy type and the combination Synchronous-Asynchronous copy type can be referred to as a Metro Global Mirror (MGM) dynamic session image. Included in tables 1-5 are explanations of when each icon is used. These tables show how the TPC-R product is using the images and are shown here to provide more information as to how the dynamic images are be created.

TABLE 1
Point-in-Time Copy Type

| Symbol | Enabled |
|---|---|
| [symbol] | Placed on the active host role. |
| [symbol] | Used for non-recoverable roles. |
| [symbol] | Used for recoverable roles. |
| [symbol] | Used if the copying flag is turned off |
| [symbol] | Used if the copying flag is turned on. |

TABLE 2
Synchronous Copy Type

| Symbol | Enabled |
|---|---|
| [symbol] | Placed on the active host role. |
| [symbol] | Used for non-recoverable roles. |
| [symbol] | Used for recoverable roles. |
| [symbol] | Used when the copying flag is turned off and H2 is |
| | specified as the active site. |
| [symbol] | Used when the copying flag is turned off and H1 is |
| | specified as the active site. |
| [symbol] | Used when the copying flag is turned on, and H2 is |
| | specified as the active site. |
| [symbol] | Used when the copying flag is turned on, and H1 is |
| | specified as the active site. |
| [symbol] | Used when the copying flag is turned off, H2 is |
| | specified as the active site, and the sequence contains errors. |
| [symbol] | Used when the copying flag is turned off, H1 is |
| | specified as the active site, and the sequence contains errors. |
| [symbol] | Used when the copying flag is turned on, H2 is specified |
| | as the active site, and the sequence contains errors. |
| [symbol] | Used when the copying flag is turned on, H1 is specified |
| | as the active site, and the sequence contains errors. |

TABLE 3
Asynchronous Copy Type

| Symbol | Enabled |
|---|---|
| [symbol] | Placed on the active host role. |
| [symbol] | Used for non-recoverable roles. |
| [symbol] | Used for recoverable roles. |
| [symbol] | Used if the copying flag is turned off |
| [symbol] | Used if the copying flag is turned on. |
| [symbol] | Used for Global Copy when the copying flag is turned |
| | off and H2 is specified as the active site. |
| [symbol] | Used for Global Copy when the copying flag is turned |
| | off and H1 is specified as the active site. |
| [symbol] | Used for Global Copy when the copying flag is turned |
| | on and H2 is specified as the active host. |
| [symbol] | Used for Global Copy when the copying flag is turned |
| | on and H1 is specified as the active host. |
| [symbol] | Used when the copying flag is turned off, H2 is specified |
| | as the active site, and the sequence contains errors. |
| [symbol] | Used when the copying flag is turned off, H1 is specified |
| | as the active site, and the sequence contains errors. |
| [symbol] | Used when the copying flag is turned on, H2 is specified |
| | as the active site, and the sequence contains errors. |
| [symbol] | Used when the copying flag is turned on, H1 is specified |
| | as the active site, and the sequence contains errors. |

TABLE 4
Combination Synchronous-Asynchronous Copy Type

| Symbol | Enabled |
|---|---|
| [symbol] | Placed on the active host role. |
| [symbol] | Used for non-recoverable roles. |
| [symbol] | Used for recoverable roles. |
| [symbol] | Used if the copying flag is turned off |
| [symbol] | Used if the copying flag is turned on. |
| [symbol] | Used when the copying flag is turned off and H2 is copying |
| | to H1. |
| [symbol] | Used when the copying flag is turned off and H1 is copying |
| | to H2. |
| [symbol] | Used when the copying flag is turned on, and H2 is copying |
| | to H1. |
| [symbol] | Used when the copying flag is turned on, and H1 is copying |
| | to H2. |
| [symbol] | Used when the copying flag is turned off, H2 is copying to |
| | H1, and the sequence contains errors. |
| [symbol] | Used when the copying flag is turned off, H1 is copying to H2, |
| | and the sequence contains errors. |
| [symbol] | Used when the copying flag is turned on, H2 is copying to H1, |
| | and the sequence contains errors. |
| [symbol] | Used when the copying flag is turned on, H1 is copying to H2, |
| | and the sequence contains errors. |
| [symbol] | Used for Global Copy when the copying flag is turned off |
| | and H3 is copying to H2. |
| [symbol] | Used for Global Copy when the copying flag is turned off |
| | and H2is copying to H3 |
| [symbol] | Used for Global Copy when the copying flag is turned on |
| | and H3 is copying to H2. |
| [symbol] | Used for Global Copy when the copying flag is turned on |
| | and H2 is copying to H3. |
| [symbol] | Used when the copying flag is turned off, H3 is copying to |
| | H2, and the sequence contains errors. |
| [symbol] | Used when the copying flag is turned off, H2 is copying to |
| | H3, and the sequence contains errors. |
| [symbol] | Used when the copying flag is turned on, H3 is copying to |
| | H2, and the sequence contains errors. |
| [symbol] | Used when the copying flag is turned on, H2 is copying to |
| | H3, and the sequence contains errors. |

TABLE 5
Special Combination Synchronous-Asynchronous Copy Type

| Symbol | Enabled |
|---|---|
| [symbol] | Used when copying from H1 to H3 is turned off, but |
| | there are errors on the sequence. |
| [symbol] | Used when copying from H3 to H1 is turned off, but |
| | there are errors on the sequence. |
| [symbol] | Used when copying from H1 to H3 is active. |
| [symbol] | Used when copying from H3 to H1 is active. |
| [symbol] | Used when copying from H1 to H3 is active, and there |
| | are errors on the sequence. |
| [symbol] | Used when copying from H3 to H1 is active, and there |
| | are errors on the sequence. |

Referring to Table 5, the combination Synchronous-Asynchronous (i.e., Metro Global Mirror) copy type includes the special arrow image 202 that spans multiple sites. This special arrow image 202 is referred to as the H1-H3 arrow, as it links the H1 to H2 to H3 roles. The H1-H3 arrow will never show in the case that the H1-H3 sequence is not copying and there are no errors on the sequence. This is to avoid over-populating the dynamic session image with unused arrows, and causing possible customer confusion. Only sequences that are playing an active role in the session can be shown in the image, with the exception of the sequences that are shown in the defined state. As such, the H1-H3 arrow is not shown if the H1-H3 sequence is not active or has errors. When the H1-H3 sequence is active and shown in the image, the H1-H2 sequence and H2-H3 sequence can not be shown. Whether a sequence arrow is shown is determined by the XML definitions.

Referring to FIGS. 1, 2 and 3, at operation 73, program 41, executed by system 20, causes system 20 to perform the operations of creating the group of dynamic images by, at operation 74, specifying how to draw site and role specific parts of the group of dynamic images. Images are drawn in the TPC-R GUI using XML definitions that tell JavaScript how to lay out the images. The JavaScript will not be responsible for any logic as to determining the state of volumes and arrows. All of these determinations are made by the Java component. The TPC-R product uses JavaScript to create these images by using the XML definitions. It is just as easy to create images some other way other than using the XML definition; however, the exemplary embodiment explains the use of JavaScript in conjunction with creating these images. There are also other ways to define the XML tags that are used in this definition. However, the exemplary embodiment describes the way TPC-R uses XML tags to define these images. The XML for a Dynamic Session Image is contained within the <tpcrm_dynamic_image>tag. This is followed by a list of site specifications and role pair specifications. Site specifications are listed within <sites> tags.

Thus, the operation 74 of specifying how to draw site and role specific parts of the group of dynamic images includes the following sub operations: a sub operation of listing a site specification in a site tag, where the site specification includes a set of up to two roles associated with the site, where a first role of the set of up to two roles is one of a source of any copy type and a target of one of a synchronous and asynchronous copy type, and a second role of the set of up to two roles is a target of a point in time copy is performed in regard to operation 74 of specifying how to draw site and role specific parts of the group of dynamic images. A site specification is declared using the <site> tag. The site tag encloses multiple <name> tags, which specify labels that are applied to the site in the session image, for example, Boulder. At this point, multiple <name> tags are supported by the XML, although the Dynamic Session Image will only draw the first name specified for the site. The <site> tag also encompasses up to two <role> tags. Each <role> tag included in the <site> tag specifies a role for the site, including a name for the role and a specification for the state of the role. Example role names can be H1, H2, H3, T1, and/or J2. The state of the role specifies which role image can be shown in the Dynamic Session Image. Table 6 shows a list of possible values and the related images.

TABLE 6
Role Images and Related XML Labels

| Symbol | Label |
|---|---|
| [symbol] | Active |
| [symbol] | Recoverable |
| [symbol] | Not Recoverable |

Another sub operation of specifying site labels in a session image by multiple name tags includes in the site tag, where the site tag includes a group of up to a first role tag and a second role tag, where each role tag specifies a role for the site, and where each role tag includes a name for each role and a specification for a state of each role is performed in regard to operation 74 of specifying how to draw site and role specific parts of the group of dynamic images.

Another sub operation of specifying, by the state of each role, a role image that can be drawn in a dynamic session image, and when the site tag includes the first role tag and the second role tag, the second role tag always specifies the target of a point-in-time copy relationship and a second role will always appear underneath a first role when the role image is drawn is performed in regard to operation 74 specifying how to draw site and role specific parts of the group of dynamic images.

Thus, in the exemplary embodiment describing the above sub operations associated with operation 74 specifying how to draw site and role specific parts of the group of dynamic images, XML code is used to define <site> and <role> tags. An exemplary listing of such XML code is shown below. Corresponding site names and role labels associated with role images resulting from the execution of this XML code in conjunction with program 41 are illustrated in FIG. 2.

```
<tpcrm_dynamic_image>
      <sites>
            <site>
                  <names>
                        <name>Boulder</name>
                  </names>
                  <role name=“H1”>
                        <recoverable> false </recoverable>
                  </role>
            </site>
            <site>
                  <names>
                        <name> Denver </name>
                  </names>
                  <role name=“H2”>
                        <recoverable> true </recoverable>
                  </role>
            </site>
            <site>
                  <names>
                        <name> Tucson</name>
                  </names>
                  <role name=“H3”>
                        <recoverable> false </recoverable>
                  </role>
                  <role name=“J3”>
                        <recoverable> true </recoverable>
                  </role>
            </site>
      </sites>
</tpcrm_dynamic_image>
```

The above XML code relates to operation 74, which specifies only how to draw the site and role specific parts of the image, not the arrows that connect the roles. The arrows are specified in operation 75 with their own separate XML, using the <rolepair> tag, where a <rolepair> tag encloses information used to draw a regular arrow between two specific role images. The <rolepair> tag encompasses five inner tags, <role>, <cptype>, <direction>, <participating>, and <active>.

Referring to FIGS. 1, 2 and 3, at operation 75, program 41, executed by system 20, causes system 20 to perform operations of specifying how to draw arrows that connect each role of the group of dynamic images. Thus, operation 75 specifying how to draw arrows that connect each role of the group of dynamic images includes the following sub operations: a sub operation of using a rolepair tag enclosing information used to draw an arrow between two specific role images, where the rolepair tag encompasses five inner tags including one or more role inner tags, or a cptype inner tag, or a direction inner tag, or a participating inner tag or an active inner tag is performed in regard to operation 75 specifying how to draw arrows.

Another sub operation of using two role inner tags to specify roles between which arrows are drawn, where names featured in the role must be the same as two of the roles specified in the role tags used to specify the sites is performed in regard to operation 75 specifying how to draw arrows that connect each role of the group of dynamic images. The names featured in the role must be the same as two of the roles specified in the <role> tags used to specify the definition of sites.

Another sub operation of specifying which type of copy is being used for arrows by the cptype inner tag, wherein the type of copy is one of point-in-time copy, synchronous copy, asynchronous copy and a combination of two or more of point-in-time copy, synchronous copy and asynchronous copy is performed in regard to operation 75 specifying how to draw arrows that connect each role of the group of dynamic images.

Another sub operation of specifying a direction to draw one or more point-in-time copy arrows, synchronous copy arrows and asynchronous copy arrows by the direction inner tag, wherein acceptable arguments for the direction inner tag are left and right is performed in regard to operation 75 of specifying how to draw arrows that connect each role of the group of dynamic images.

Another sub operation of selecting one of filled and unfilled icons representing arrows by the active inner tag is performed in regard to operation 75 specifying how to draw arrows that connect each role of the group of dynamic images.

Certain sequences are kept track of by TPC for Replication that can not always be shown in the Dynamic Session Image. The <participating> tag is used to mark whether the arrow for the sequence can be shown in the image. For example, the H1-H3 sequence will only be shown in the image at certain times. In addition, at times the H1-H2 and H2-H3 images will not always be shown. Thus, another sub operation of marking with the participating inner tag when arrows can be shown in the group of dynamic images is performed in regard to operation 75 specifying how to draw arrows that connect each role of the group of dynamic images.

In the exemplary embodiment describing the above sub operations associated with operation 75 of specifying how to draw regular arrows that connect each role of the group of dynamic images, exemplary XML code defining the above described sub operations of operation 75 of specifying how to draw arrows is listed below. Corresponding regular arrow images associated with role images resulting from the execution of this XML code in conjunction with program 41 are illustrated in FIG. 2.

```
<tpcrm_dynamic_image>
      <sites>
            <site>
                  <names>
                        <name>Boulder</name>
                  </names>
                  <role name=“H1”>
                        <recoverable> false </recoverable>
                  </role>
            </site>
            <site>
                  <names>
                        <name> Denver </name>
                  </names>
                  <role name=“H2”>
                        <recoverable> true </recoverable>
                  </role>
            </site>
            <site>
                  <names>
                        <name> Tucson</name>
                  </names>
                  <role name=“H3”>
                        <recoverable> false </recoverable>
                  </role>
                  <role name=“J3”>
                        <recoverable> true </recoverable>
                  </role>
            </site>
      </sites>
      <rolepairs>
            <rolepair>
                  <role>H1</role>
                  <role>H2</role>
                  <cptype>MM</cptype>
                  <active>true </active>
                  <direction>right</direction>
                  <errors>false</errors>
                  <participating>true</participating>
            </rolepair>
            <rolepair>
                  <role>H2</role>
                  <role>H3 </role>
                  <cptype>GC</cptype>
                  <active>true</active>
                  <direction>right</direction>
                  <errors>false</errors>
                  <participating>true<participating>
            </rolepair>
            <rolepair>
                  <role>H3</role>
                  <role>J3</role>
                  <cptype>FC</cptype>
                  <active>true</active>
                  <errors>false</errors>
                  <participating>true</participating>
            </rolepair>
      </rolepairs>
</tpcrm_dynamic_image>
```

The above XML code specifies how to draw both the site and role specific parts of the image, as well as the arrows that connect the roles; thus representing the group of data replication states.

Referring to FIGS. 1, 2 and 3, at operation 76, program 41, executed by system 20, causes system 20 to perform the operations of displaying on display 21 the group of data replication states to the customer.

Referring to FIGS. 1, 2 and 3, at operation 77, program 41, executed by system 20, causes system 20 to generate the entire copy solution model definition that is used to graphically display an entire copy solution, where the entire copy solution may can be a zero data loss solution or one or more different types of copy solutions, based on customer/user needs; and operation 78 generates the dynamic visual display of the entire copy solution using the copy solution model definition to cause the user to see the dynamic visual display of the entire copy solution.; thereby, providing customers a way to visualize what their data is actually doing at any given time, when copying data to storage devices configured as a plurality of networked storage devices 51, as illustrated in FIG. 3, especially when dealing with little to zero data loss disaster recovery solutions, where administrative management of the data replication solutions is very complex. In the exemplary embodiment, system 20 can also show which site is available to be written to by application hosts. Therefore, at any given time (depending on where the data is being copied or not), the customer can setup their applications to write to a certain site (a set of volumes listed as H1, H2, J1, J2, I1, etc). Thus, it is possible to show which sites are available to be written to by the customer applications. Different site images represent different sites that are available to receive applications to be written to, such that a glowing image or a triangle above the site indicates that customer can move their applications over to write data to the new site having the glowing image indicator or the triangle indicator. Further, the exemplary embodiment can show by way of an indicator where a site is located on the network that the customer application is currently writing its data to the storage. This indicator is a different identifier that would just tell customers/users where their data is currently being written at a given time. By the customers/users being able to determine visually that they can direct their client applications and/or systems to write their data to an alternate site location they can then suspend the copy solution currently being written/stored and then the customers/users can decide to direct their systems to write (i.e., store) their data to a different, new, site location other than the site location they are currently writing their data to, in order to prevent or mitigate delays in replication of data and/or to prevent data loss. The indicator can be a glowing color indicator, or a circle or other indicator showing where the customer data is being written. Thus, there can be two different identifiers. One that would show where the customer application can write data given the state of the copy solution (which can be over a number of sites) and the other being where the customer/user applications are currently writing data (which can only be in one place at any given time for the single copy solution). At operation return/end 79, method 70 can be directed by program 41 to return to any of the above operations and/or sub operations to continue iteratively processing and performing said operations and sub operations for a plurality of copy solutions or when there are no other requirements or requests to determine copy solutions, then program 41 can direct method 70 to end.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method for modeling a set of images representing a data replication solution and displaying the data replication solution to a user, the method comprising:
creating an image data modeling definition; wherein the image data modeling definition includes a definition of a set of images representing a group of data replication states;
creating a group of static images, using the definition of the set of images representing the group of data replication states included in the image data modeling definition, wherein the group of static images is used to display a dynamic visual display of an entire copy solution, wherein creating the group of static images includes:
specifying how to draw site and role specific parts of the group of static images used to display the dynamic visual display of the entire copy solution by:
listing a site specification in a site tag, wherein the site specification includes a set of up to two roles associated with the site, wherein a first role of the set of up to two roles is one of a source of any copy type and a target of one of a synchronous and asynchronous copy type, and a second role of the set of up to two roles is a target of a point in time copy;
specifying site labels in a session image by multiple name tags includes in the site tag, wherein the site tag includes a group of up to a first role tag and a second role tag, wherein each role tag specifies a role for the site, and wherein each role tag includes a name for each role and a specification for a state of each role;
specifying, by the state of each role, a role image that can be drawn in a dynamic session image, and wherein when the site tag includes the first role tag and the second role tag, the second role tag always specifies the target of a point-in-time copy relationship and a second role always appears underneath a first role when the role image is drawn; and
specifying how to draw arrows that connect each role of the group of static images to create the dynamic visual display of the entire copy solution by:
using a rolepair tag enclosing information used to draw an arrow between two specific role images, wherein the rolepair tag encompasses five inner tags including one or more role inner tags, a cptype inner tag, a direction inner tag, a participating inner tag and an active inner tag;
using two role inner tags to specify roles between which arrows are drawn, wherein names featured in the role must be the same as two of the roles specified in the role tags used to specify the sites;
specifying which type of copy is being used for arrows by the cptype inner tag, wherein the type of copy is one of point-in-time copy, synchronous copy, asynchronous copy and a combination of two or more of point-in-time copy, synchronous copy and asynchronous copy;
specifying a direction to draw one or more point-in-time copy arrows, synchronous copy arrows and asynchronous copy arrows by the direction inner tag, wherein acceptable arguments for the direction inner tag are left and right;
selecting one of filled and unfilled icons representing arrows by the active inner tag; and
marking with the participating inner tag when arrows can be shown in the group of dynamic images;
displaying the group of data replication states to the user;
generating the entire copy solution model definition that is used to graphically display an entire copy solution, where the entire copy solution can be a zero data loss solution or one or more different types of copy solutions, based on user needs; and
generating the dynamic visual display of the entire copy solution using the entire copy solution model definition to cause the user to see the dynamic visual display of the entire copy solution; wherein the user can direct their applications to write replication data to an alternate site location and prevent delays in data replication and prevent data loss.

2. The method according to claim 1, wherein a plurality of different images are generated for the set of images representing the group of data replication states.

3. The method according to claim 2, wherein the plurality of different images includes an image that shows where the user application can write data given the state of the copy solution and where the user applications are currently writing data.

4. The method according to claim 1, wherein XML is used to create the image data modeling definition of the plurality of different images generated for the set of images representing the group of data replication states.

5. A system for modeling a set of images representing a data replication solution and displaying the data replication solution to a user, the system comprising:
a network host computer processor containing a plurality of units including a program unit and at least one algorithm unit, wherein the network host computer processor is cooperatively coupled to a plurality of network computers, and network storage devices over a network;
a computer executable program residing in the program unit, wherein the computer executable program when executed by the network host computer processor causes the network host computer processor to:
create an image data modeling definition; wherein the image data modeling definition includes a definition of a set of images representing a group of data replication states;
create a group of static images, using the definition of the set of images representing the group of data replication states included in the image data modeling definition, wherein the group of static images is used to display a dynamic visual display of an entire copy solution, wherein creation of the group of static images includes the computer executable program when executed by the network host computer processor causing the network host computer processor to:
specify how to draw site and role specific parts of the group of static images used to display the dynamic visual display of the entire copy solution by:
listing a site specification in a site tag, wherein the site specification includes a set of up to two roles associated with the site, wherein a first role of the set of up to two roles is one of a source of any copy type and a target of one of a synchronous and asynchronous copy type, and a second role of the set of up to two roles is a target of a point in time copy;
specifying site labels in a session image by multiple name tags includes in the site tag, wherein the site tag includes a group of up to a first role tag and a second role tag, wherein each role tag specifies a role for the site, and wherein each role tag includes a name for each role and a specification for a state of each role;
specifying, by the state of each role, a role image that can be drawn in a dynamic session image, and wherein when the site tag includes the first role tag and the second role tag, the second role tag always specifies the target or a point-in-time copy relationship and a second role always appears underneath a first role when the role image is drawn; and
specify how to draw arrows that connect each role of the group of static images to create the dynamic visual display of the entire copy solution by:
using a rolepair tag enclosing information used to draw an arrow between two specific role images, wherein the rolepair tag encompasses five inner tags including one or more role inner tags, a cptype inner tag, a direction inner tag, a participating inner tag and an active inner tag;
using two role inner tags to specify roles between which arrows are drawn, wherein names featured in the role must be the same as two of the roles specified in the role tags used to specify the sites;
specifying which type of copy is being used for arrows by the cptype inner tag, wherein the type of copy is one of point-in-time copy, synchronous copy, asynchronous copy and a combination of two or more of point-in-time copy, synchronous copy and asynchronous copy;
specifying a direction to draw one or more point-in-time copy arrows, synchronous copy arrows and asynchronous copy arrows by the direction inner tag, wherein acceptable arguments for the direction inner tag are left and right;
selecting one of filled and unfilled icons representing arrows by the active inner tag; and
marking with the participating inner tag when arrows can be shown in the group of dynamic images;
display the group of data replication states to the user;
generate the entire copy solution model definition that is used to graphically display an entire copy solution, where the entire copy solution can be a zero data loss solution or one or more different types of copy solutions, based on user needs; and
generate the dynamic visual display of the entire copy solution using the entire copy solution model definition to cause the user to see the dynamic visual display of the entire copy solution; wherein the user can direct their applications to write replication data to an alternate site location and prevent delays in data replication and prevent data loss.

6. The system according to claim 5, wherein a plurality of different images are generated for the set of images representing the group of data replication states.

7. The system according to claim 6, wherein the plurality of different images includes an image that shows where the user application can write data given the state of the copy solution and where the user applications are currently writing data.

8. The method according to claim 5, wherein XML is used to create the image data modeling definition of the plurality of different images generated for the set of images representing the group of data replication states.
